(19) United States
(12) Patent Application Publication
(10) Pub. No.: US 2020/0353477 A1
(43) Pub. Date: Nov. 12, 2020

(54) ORE-DRESSING PROCESS

(71) Applicant: AMG MINERAÇÃO S.A., Minas Gerais (BR)

(72) Inventors: Lucas Resende Fazzion, Minas Gerais (BR); Vantuir Damasio De Almeida, Minas Gerais (BR); Carlos Valdir Gusmao, Minas Gerais (BR)

(21) Appl. No.: 16/762,112

(22) PCT Filed: Jul. 24, 2018
(86) PCT No.: PCT/BR2018/000042

§ 371 Date: May 6, 2020

(30) Foreign Application Priority Data
Nov. 7, 2017 (BR) 10 2017 023903 9

(51) Int. Cl. B03B 7/00; B02C 23/20; B03D 1/14; B03C 1/00; B03C 1/30

(52) U.S. Cl. CPC B03B 7/00; B02C 23/20; B03D 1/1406; B03C 2201/20; B03C 1/30; B03D 2203/04; B03C 1/002

(57) ABSTRACT

This invention applies to the field of ore processing processes aiming to provide a reduction or increase in the concentration of one of its constituents, as well as describes a process to concentrate the lithium oxide content from pegmatite rock from the tailings of heavy mineral gravimetric concentration recovery processes.

### FIELD OF APPLICATION

This invention applies to the field of ore processing processes aiming to provide a reduction or increase in the concentration of one of its constituents. This invention describes a process for the concentration of pegmatite rock lithium oxide from the tailings of heavy mineral gravimetric concentration recovery processes.

### PRINCIPLES OF THE INVENTION

Lithium is an alkaline, highly reactive metal that possesses high electrochemical potential; however, it does not occur in nature as a pure element, being found in the form of a mineral or a salt.

Lithium is a lightweight metal and the most electropositive of the metallic elements. It has a silvery shine and is also found on the magmatic rocks. Lithium does not occur freely in nature and, even combined, is far from abundant. It is quite distributed in the earth's crust, being assigned a percentage in the order of 0.004%. Lithium compounds are obtained from the minerals: spodumene, lepidolite, amblygonite or petalite, which are lithium aluminosilicates.

Pegmatites are igneous rocks with a coarse granulometry formed by the crystallization of post-magmatic liquids. The pegmatites are associated with their intrusive neighbors. Mineralogically the granitic pegmatites contain feldspar, quartz and mica as main components, and a variety of ancillary elements such as lithium, beryllium, tantalum, tin and cesium that can occur or not in economically significant concentrations (Luz et al., 2003).

This invention describes a process for ore processing promoting the concentration of lithium oxide above 5.5% present in the lytic feldspar or directly from the pegmatite.

Although techniques and processes already exist for the concentration of lithium oxide from lytic feldspar or directly from pegmatite, the studies that have been performed have the intention of perfecting this process in order to guarantee a product with higher concentration of lithium oxide and metallurgical recovery.

Thus, the present invention is related to a more efficient flotation stage resulting from a study with several process conditions capable of promoting a more optimized process and with better results in terms of metallurgical recovery.

### HISTORY OF THE INVENTION

The American document U.S. Pat. No. 4,098,687 describes a method for ore processing that obtains lithium oxide through flotation. In this method, the flotation stage should preferably be carried out without the desliming stage, where a dispersant is used. An anionic selectivity stage is also performed for flotation.

Document CN103934112 describes a lithium oxide processing method that comprises the lithium ore milling stages, addition of sodium hydroxide to the sludge, addition of water to the pulp and flotation in two stages, one for the lepidolite and another for the spodumene.

Document CN104258979 describes a feldspar ore processing process. This process includes milling, magnetic separation and flotation; however, its purpose is to reduce the concentration of ferrous compounds in the referred ore.

Document CN104923384 describes a feldspar ore processing process. It consists of milling, magnetic separation and flotation stages. As the document mentioned above, the purpose of this process is also to reduce the content of ferrous compounds.

Although the above documents are also within the scope of lithium processing, the present invention differs from the documents analyzed herein, since, in addition to having a magnetic separation stage prior to flotation to remove compounds containing iron in their crystalline structures, it also presents an optimization of the flotation stage, ensuring a process superior to that found in the state of the art.

This processing process is relevant when adding value to the processing of Tantalum tailings, concentrating the lithium oxide present in it, making it commercially interesting.

So far, no lithium oxide processing process had been described, concentrating the same in the lytic feldspar ores or directly from the pegmatite, with the sequence of stages as proposed in this invention, as well as with the reagents used in the flotation stage.

The main barrier to the above lithium oxide concentration in minerals is the presence of certain contaminants, such as sodium, potassium, calcium and minerals containing Fe₂O₃. The present invention comprises an arrangement of the stages, in order to avoid the interference of said contaminants, such as the relocation of the magnetic separation before the flotation stages, ensuring a product with higher concentration and metallurgical recovery.

### SUMMARY OF THE INVENTION

The present invention comprises a process for ore processing, capable of promoting lithium oxide concentrations above 5.5% to 6.5% promoted through an optimization of the flotation stage.

This optimization capacity is achieved through an adequate sequence of the stages of this process, as well as with the conditions under which the flotation stage occurs.

### DETAILED DESCRIPTION OF THE INVENTION

This invention describes a process capable of promoting the concentration of lithium oxide in tailings coming from the gravimetric plant and/or from the pegmatite in the mine.

This process comprises the following stages: milling, classification, desliming, magnetic separation (in two stages) and flotation (in two stages).

The process is fed with the pegmatite ROM, with the tailings from gravimetric plants and as well as with tailings stored in the dam.

Initially, the ore is milled to ensure an adequate size for subsequent stages. To ensure that the size of this particle at the milling stage is reached, the classification stage guarantees the size, returning the particles to the milling stage if the classification is negative.

The pegmatite ore is then submitted to a desliming stage.

This desliming stage involves the removal of the ultra-fine particles (−0,038 mm), which increase the consumption of reagent and reduce the metallurgical recovery of the process.

This desliming stage can occur in hydro-cyclones or in classification spirals.

Two flows are obtained from this desliming stage: the sludge and the deslimed material, which is the feed flow of the next stage: magnetic separation.

The deslimed material follows to the magnetic separation stage, which occurs in two stages, rougher and cleaner, with the purpose of removing contaminants present in the flow resulting from the desliming stage. The magnetic separation stage takes place in two or three stages in order to remove minerals that include Fe₂O₃ in their composition. Magnetic separation occurs in the Rougher/Cleaner or Rougher/Cleaner/Recleaner stages in WHIMS (Wet High Intensity Magnetic Separation) type separators having magnetic fields above 10,000 Gauss.

From this magnetic separation stage, the magnetic material (tailing) is obtained, which follows on to the tailings thickener and dewatering operation. The non-magnetic flow is directed to the flotation stage.

The flotation stage comprises regularization, so that the pH remains controlled between 6.5 and 7.5, pulp conditioning with fatty acid and sodium aliphatic sulfocarboxylate with a carbon chain differentiated from the fatty acids as a mixture of collecting reagents, as well as flotation in two stages, rougher and cleaner. As in any concentration operation, for flotation it is also difficult to obtain the desired metallurgical content and recovery in a single stage. In general, a first flotation is performed, called “rougher”, where a poor concentrate and tailings that still contain useful mineral contents is obtained. The concentrate is washed again in a second flotation, called “cleaner”, where a final concentrate and low content tailings are produced.

The flotation stage begins in the conditioning tank, where fatty acids are added, as well as compounds derived from the same, in concentrations between 150 g/t and 400 g/t, in addition to aliphatic sodium disulfocarboxylate in concentrations between 50 g/t and 150 g/. They are intended to increase the flotability of lithium-containing minerals.

From this conditioning tank, the pulp obtained is sent to the first stage of flotation: Rougher flotation that occurs in mechanical flotation cells.

In the Rougher flotation stage a commercial foaming agent is added to the feed box of the first mechanical flotation cell.

The second stage of flotation is the Cleaner flotation, performed by mechanical flotation cells. The tailings from the Cleaner flotation flow back into the Rougher flotation feed.

The final concentrate obtained from the flotation stages goes on to the filtering stage, with a humidity of 10%.

After this filtering stage, the concentrate goes on to the drying stage, where a product with a humidity of up to 2% is obtained.

The concentrate conveying system comprises pneumatic pumps, silos, filters and a bagging station.

The pneumatic pump of the conveying system sends the concentrate to the feed silo, which transports the concentrate to one of the four quality control silos.

The quality control silos have a volume of 50 m³.

The quality control silos can store the product for approximately six hours at nominal feed rates. From these quality control silos, the product is transported to one of the four storage silos.

The choice of receiving silos is based on the quality of the product. These receiving silos have a volume of 200 m³.

The blending silo has a pneumatic pump, capable of pumping the concentrate into the bagging system.

In this packing system, the final product is packed in Big Bags of approximately one and a half tons, and then transported and stored for 24 days.

The present invention has been disclosed in this description in terms of its preferred embodiment. However, other modifications and variations are possible based on this description, and are still inserted within the scope of the invention revealed herein.

1-14. (canceled)

15. A process for ore processing including Ore milling to ensure proper particle size and Ore size classification for the return of inadequate particles, said process comprising the steps of:
desliming pegmatite ore to obtain deslimed material;
subjecting said deslimed material to a magnetic separation process including a rougher magnetic separation step followed by a cleaner magnetic separation step to obtain non-magnetic material; and
subjecting said non-magnetic material to a flotation process including a rougher flotation step followed by a cleaner flotation step in order to obtain lithium oxide.

16. The process according to claim 15, wherein the desliming step further comprises removing ultrafine particles smaller than 0.038 mm.

17. The process according to claim 15, wherein sludge including tailings are further obtained during the desliming step.

18. The process according to claim 15, wherein minerals containing Fe₂O₃ in their crystalline structure are removed during the magnetic separation process prior.

19. The process according to claim 15, wherein the magnetic separation process removes Fe₂O₃ present in the deslimed material obtained in the desliming step.

20. The process according to claim 15, wherein pH is controlled and pulp is conditioned with a mixture of collecting reagents during the flotation process.

21. The process according to claim 20, wherein said pH is between 6.5 and 7.5.

22. The process according to claim 20, wherein said mixture of collecting reagents comprises fatty acids in concentrations from 150 g/t to 400 g/t, and sodium aliphatic sulfocarboxylate with a carbon chain differentiated from the fatty acids, in concentrations from 50 g/t to 150 g/t.

23. The process according to claim 15, wherein the rougher flotation step and the cleaner flotation step are carried out on mechanical flotation cells.

24. The process according to claim 23, wherein a commercial foaming agent is added to the mechanical flotation cell used during the rougher flotation step.

25. The process according to claim 15, wherein a recycle system is used during the cleaner flotation step for returning tailings present in a cleaner flotation flow back to said rougher flotation step.

26. The process according to claim 15, wherein pegmatite ROM resulting from tailings of a heavy mineral gravimetric concentration process is used as a feed stream for the process.

27. The process according to claim 15, wherein said ore is spodumene.

28. The process according to claim 15, wherein said lithium oxide is obtained in concentrations between 5.5% and 6.5%.
